(19) United States
(12) Patent Application Publication
(10) Pub. No.: US 2006/0026518 A1
(43) Pub. Date: Feb. 2, 2006

(54) Apparatus and method for processing text data according to script attribute

(75) Inventors: Kil-soo Jung, Hwaseong-gun (KR); Sung-ryeul Rhyu, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/190,875

(22) Filed: Jul. 28, 2005

(30) Foreign Application Priority Data
Jul. 30, 2004 (KR) 2004-60117
Jul. 14, 2005 (KR) 2005-63765

(51) Int. Cl. G06F 17/00

(52) U.S. Cl. 715/542

(57) ABSTRACT

A method of and an apparatus for processing text data recorded on an information storage medium according to an attribute of the text data. One of a plurality of script categories classified according to a language attribute of the text data is extracted; and the text data according to script information included in the extracted category is rendered. Script category information classified by scripts is stored as language information that a text generator included in a reproducing apparatus can process, and text data is processed using the stored language information.

### CROSS-REFERENCE TO RELATED APPLICATIONS

This application claims the priority of Korean Patent Application No. 2005-63765, filed on Jul. 14, 2005 and No. 2004-60117, filed on Jul. 30, 2004, in the Korean Intellectual Property Office, the disclosures of which are incorporated herein by reference.

### BACKGROUND OF THE INVENTION

1. Field of the Invention

Aspects of the present invention relate to processing text data, and more particularly, to a method of and an apparatus for processing text data recorded on an information storage medium according to attributes of the text data.

2. Description of the Related Art

Text is converted into text data encoded in various languages and then stored in an information storage medium. When a user selects some of the text data encoded in various languages, a reproducing apparatus reads the selected text data, renders the selected text data using a text generator, and displays the rendered text data on a screen.

Since the text data encoded in various languages is stored in the information storage medium, the reproducing apparatus needs a lot of resources to process and display the text data. In addition, the information storage medium should store information regarding languages that can be processed by the reproducing apparatus. However, a reproducing apparatus with limited resources, such as consumer electronics, requires a text generator dedicated for supported languages.

### SUMMARY OF THE INVENTION

Aspects of the present invention provide a method of and an apparatus for processing text data, which classify scripts, defined by attribute information indicating how text data created in various languages is processed, into categories and process the text data according to the categories using a reproducing apparatus.

An aspect of the present invention also provides a reproducing apparatus dedicated for a certain language that processes text data more efficiently.

According to an aspect of the present invention, there is provided a method of processing text data. The method includes: extracting one of a plurality of script categories classified according to a language attribute of the text data; and rendering the text data according to script information included in the extracted category.

Each of the script categories may include a plurality of script information, and scripts may be used to process units of a plurality of Unicode symbols. The script may be a script used to express a character set in the Unicode.

The script categories may indicate information regarding languages supported by a reproducing apparatus. The script categories may be stored as system parameters of the reproducing apparatus.

According to another aspect of the present invention, there is provided an information storage medium storing: text data encoded in a plurality of languages; and script category information classified according to a language attribute of the text data.

According to another aspect of the present invention, there is provided an apparatus for processing text data. The apparatus includes: an extractor extracting one of a plurality of script categories classified according to a language attribute of the text data; and a text generator rendering the text data according to script information included in the extracted category.

According to another aspect of the present invention, there is provided a reproducing apparatus including: a text data storing unit storing text data encoded in a plurality of languages and script category information classified according to a language attribute of the text data; and a text data processing unit reading the text data and rendering the text data according to script information included in the script category information.

According to another aspect of the present invention, there is provided a computer-readable recording medium on which a program for executing a method of processing text data is recorded, the method including: extracting one of a plurality of script categories classified according to a language attribute of the text data; and rendering the text data according to script information included in the extracted category.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1A illustrates a process of processing and outputting text data using a text generator;

FIG. 1B illustrates a process of outputting text data when a bi-directional attribute value is “right-to-left”;

FIG. 1C illustrates a process of rendering text data when the text generator includes Arabic script information to correctly display bundles of numbers and signs;

FIG. 1D illustrates a process of rendering text data when Hebrew script information is added to the text generator;

FIG. 2A and FIG. 2B illustrate information regarding language codes that can be processed by the text generator included in a reproducing apparatus based on scripts according to an embodiment of the present invention;

FIG. 3 is a block diagram of a reproducing apparatus according to an embodiment of the present invention; and

FIG. 4 is a flowchart illustrating a method of processing text data according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

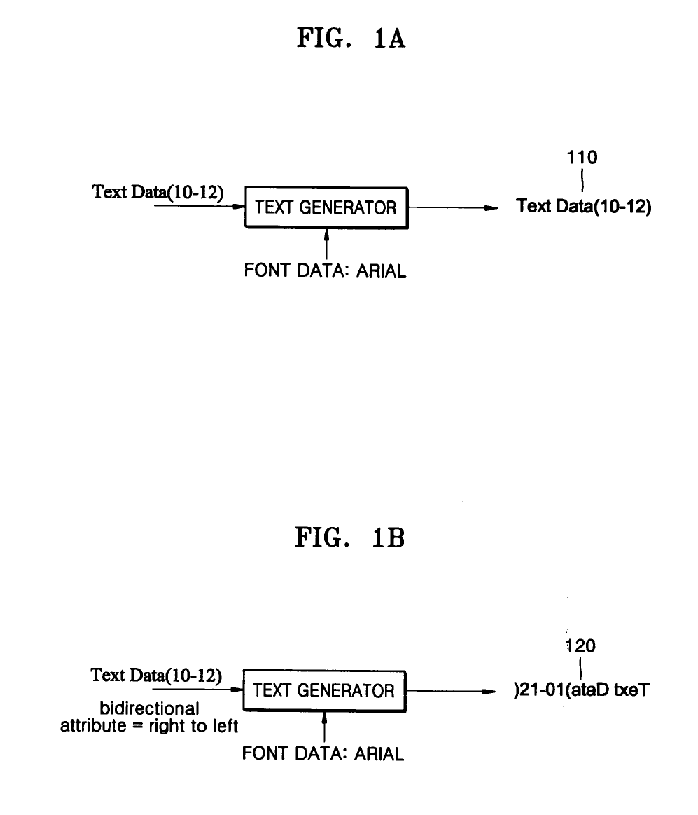

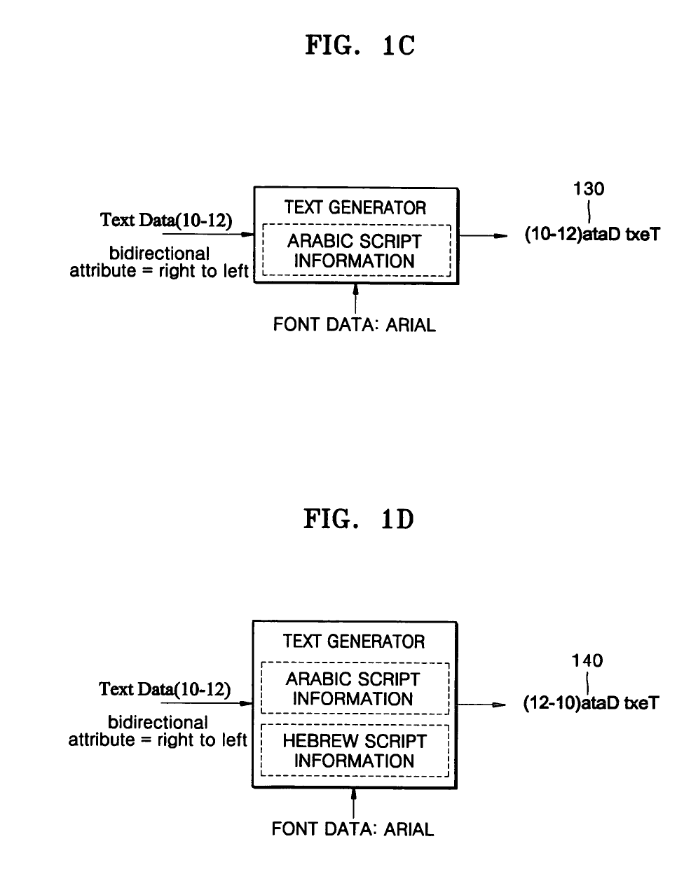

FIG. 1A illustrates a process of processing and outputting text data using a text generator. Referring to FIG. 1A, the text generator receives text data and font data, and renders and outputs the text data. For example, if the text data “Text Data (10-12)” is created in English and the font data of Arial font, the text generator processes the text data “Text Data (10-12)” using the Arial font. Then, the text data 110 “Text Data (10-12)” is displayed on a screen. Each component of the text data, for example, ‘(,’ ‘T,’ ‘1,’ or ‘-’ is called a symbol, and various scripts may be generated according to how the text data is processed. For example, a “left-to-right” script is for displaying the text data from left to right, and an “Arabic” script is for processing a unit of numbers and/or signs at a time. Displaying signs using a script is useful where a particular sign has a different meaning when displayed among right to left text from the meaning of the sign displayed among left to right text. Displaying a combination of numbers and signs using a script is also useful where, according to customary usage of a particular language, the combination is to be displayed in a different order from an order in which the combination would be displayed if presented in another language.

In other words, scripts may be included in the text generator of a reproducing apparatus as programs for executing a method of processing a plurality of symbols with a same attribute. Therefore, processing units of text data vary according to script information. While a font is applied to each symbol, a script is applied to a plurality of symbols with the same attribute.

In FIG. 1A, the text data “Text Data (10-12)” is rendered in units of symbols. Unless a certain attribute value is allocated when an information storage medium storing text data is manufactured, the “Text Data (10-12)” created in English has a “left-to-right” value as a bi-directional attribute value. As a result, the text data 110 “Text Data (10-12)” is output.

FIG. 1B illustrates a process of outputting text data when the bi-directional attribute value is “right-to-left”. Since the text generator renders the text data 120 “Text Data (10-12)” in units of symbols, symbols are output one by one from right to left. As a result, “)21-01 (ataD txeT” 120 is output as illustrated in FIG. 1B. When processed in units of symbols, numbers and signs are output incorrectly, whereas letters are output correctly. Therefore, the text generator includes attribute information, that is, scripts, to correctly display symbols with the same attribute.

FIG. 1C illustrates a process of rendering the text data “Text Data (10-12)” when the text generator includes Arabic script information to correctly display bundles of numbers and signs. Referring to FIG. 1C, the text generator renders the text data “Text Data (10-12)” in units of scripts instead of symbols. Using the Arabic script information, the text generator renders numbers and signs in units of scripts. Hence, a word including numbers, for example, text data “(10-12),” is correctly displayed as “(10-12) ataD txeT” 130 as if the numbers and signs are regarded as one symbol.

FIG. 1D illustrates a process of rendering text data “Text Data (10-12)” when Hebrew script information is added to the text generator. In other words, if the text generator can process information regarding “Hebrew script,” 10 and 12 are separately processed and thus displayed as “(12-10)”, not “(10-12)”. Consequently, “(12-10) ataD txeT” 140 is output.

As described above, the text generator renders text data in units of scripts instead of symbols. Therefore, aspects of the present invention provides a text generator which has only language information that can be processed by the text generator, not all of the language information requiring a lot of resources.

In particular, the text generator using the script category information according to an aspect of the present invention does not require the script information regarding all languages. The text generator only has to include script information regarding certain languages supported by a reproducing apparatus to efficiently use the limited resources of the reproducing apparatus. That is, a reproducing apparatus supporting languages of certain areas more efficiently may be provided.

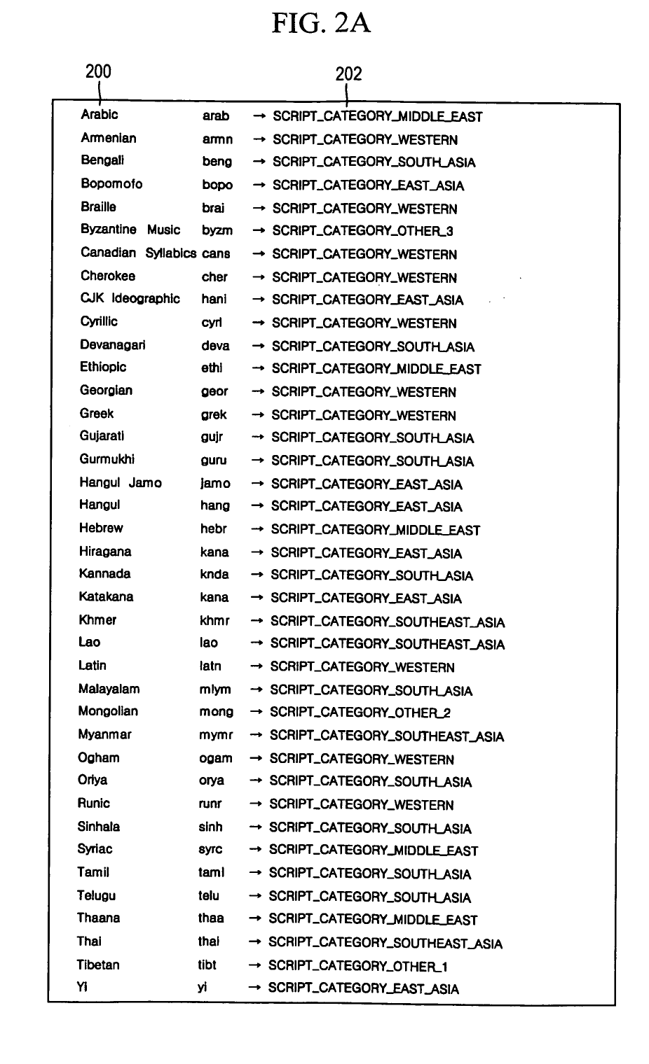

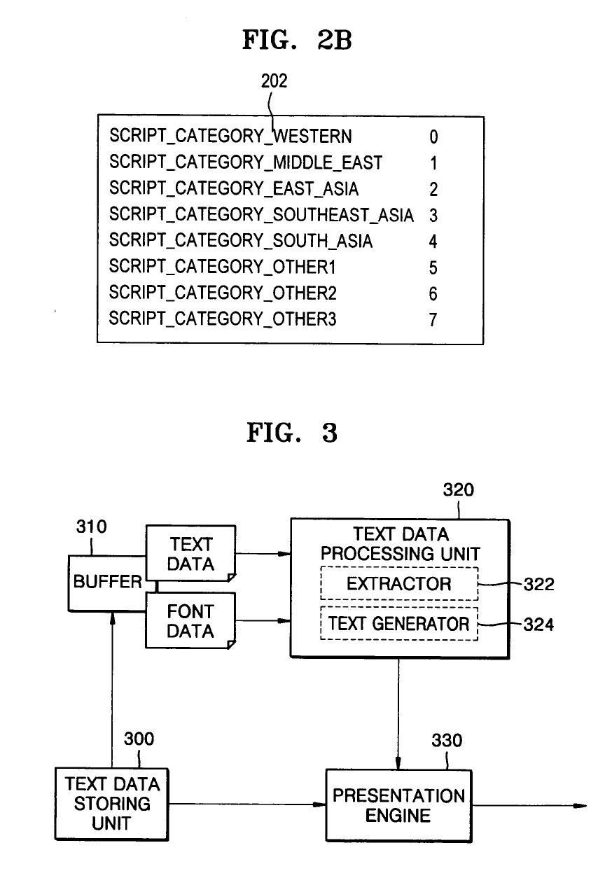

FIG. 2A and FIG. 2B illustrate information regarding language codes that can be processed by the text generator included in the reproducing apparatus based on scripts according to an embodiment of the present invention. Referring to FIG. 2A, a conventional reproducing apparatus includes language information 200 that the reproducing apparatus can process for each language. For example, text data created in Korean (Hangul) includes English, numbers, signs, Greek characters, and so on. Therefore, system parameters of the reproducing apparatus must have attribute information, i.e., script information, such as “Arabic,” “Hangul,” and “Greek” to process such various languages.

That is, text data created in one language generally includes more than 100 types of script information as described above, thereby requiring a lot of resources of the reproducing apparatus. To solve this problem, according to aspects of the present invention, language codes having the same script information are grouped into categories 202 as shown in FIG. 2A.

In this case, a script which expresses a character set in Unicode is used. A script using a character set in the Unicode is illustrated in FIG. 2B. As illustrated in FIG. 2B, languages may be divided into about eight categories according to the types of scripts. Information indicating that the text generator in the reproducing apparatus can process at least one category is stored in a form of system parameters. Hence, all scripts included in a category can be processed.

Where an information storage medium that stores text data created in a plurality of languages is reproduced by the reproducing apparatus, if a user selects a language, the reproducing apparatus identifies a script to use based on a Unicode value and determines whether the script can be rendered by the text generator with reference to the script information stored in the system parameters.

In addition, since script category information 202 corresponding to languages supported by the reproducing apparatus is designated by the system parameters of the reproducing apparatus and the text generator included in the reproducing apparatus only has to include script information corresponding to the designated category information 202, a reproducing apparatus for a language of a certain region may be provided using few resources.

FIG. 3 is a block diagram of a reproducing apparatus according to an embodiment of the present invention. Referring to FIG. 3, a text data processing unit 320 renders text data. The text data may be recorded on an information storage medium or in a memory included in the reproducing apparatus. In FIG. 3, the information storage medium or the memory storing text data is represented as a text data storing unit 300.

A text data file corresponding to a moving image being reproduced and font data to be used when the text data is rendered are read from the text data storing unit 300 and stored in a buffer 310. The text data stored in the buffer 310 is transmitted to the text data processing unit 320, which parses information needed to render text. Further, caption text, font information, rendering style information, etc., required to render the text are transmitted to the text data processing unit 320. Then, the text data processing unit 320 renders the text data and creates a bitmap image. Also, the text data processing unit 320 designates an output start time and an output end time of each item of the text, generates output data, and transmits the output data to a presentation engine 330.

The text data processing unit 320 includes an extractor 322 extracting one of a plurality of script categories classified according to the language attribute of the text and a text generator 324 rendering the text data according to script information included in an extracted category.

The presentation engine 330 combines the bitmap image of text data stored in the text data storing unit 300 with the text data rendered by the text data processing unit 320 and outputs the combination result to a display device.

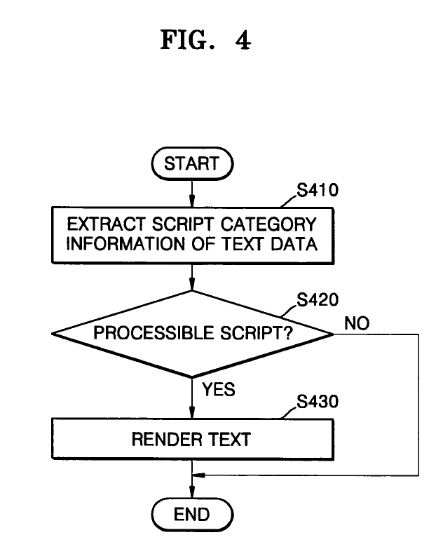

FIG. 4 is a flowchart illustrating a method of processing text data according to an embodiment of the present invention. Referring to FIG. 4, one of a plurality of script categories classified according to a language attribute is extracted (S410). It is determined whether the extracted script category is a processable script category stored in system parameters of a reproducing apparatus (S420). If it is determined that the extracted script category can be processed by the reproducing apparatus, text data is rendered according to script information included in the extracted script category (S430). If it is determined that the extracted script category cannot be processed, the processing of the text data is terminated.

As described above, according to aspects of the present invention, script category information classified by scripts is stored as language information that a text generator included in a reproducing apparatus can process, and text data is processed using this language information, thereby preventing a waste of resources.

In addition, script category information corresponding to a language of a certain region supported by the reproducing apparatus is designated as a system parameter of the reproducing apparatus, and the text generator of the reproducing apparatus includes script information included in the designated script category information only. Therefore, a text generator for a language of a certain region can be provided in a reproducing apparatus with limited resources.

In addition, a reproducing apparatus supporting a language of a certain region more efficiently can be provided.

Aspects of the present invention can also be implemented as computer-readable code on a computer-readable recording medium. Code and code segments for accomplishing the aspects of the present invention can be easily construed by programmers skilled in the art to which the present invention pertains.

The computer-readable recording medium may be any data storage device that can store data which can be thereafter read and executed by a computer. Examples of the computer-readable recording medium include magnetic recording mediums, optical recording mediums, and carrier waves.

The computer-readable recording medium can also be distributed over network-coupled computer systems so that the computer-readable code is stored and executed in a distributed fashion.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of processing text data, the method comprising:
extracting one of a plurality of script categories classified according to a language attribute of the text data; and
rendering the text data according to script information included in the extracted script category.

2. The method of claim 1, wherein each of the script categories comprises a plurality of script information, and scripts are used to process units of a plurality of Unicode symbols.

3. The method of claim 2, wherein each script is used to express a character set in the Unicode.

4. The method of claim 1, wherein the script categories indicate information regarding languages supported by a reproducing apparatus.

5. The method of claim 4, wherein the script categories are stored as system parameters of the reproducing apparatus.

6. An information storage medium storing:
text data encoded in a plurality of languages; and
script category information classified according to a language attribute of the text data.

7. The medium of claim 6, wherein the script category information comprises a plurality of script information, and scripts are used to process units of a plurality of Unicode symbols.

8. The medium of claim 7, wherein the script is a script used to express a character set in the Unicode.

9. The medium of claim 6, wherein the script category information indicates information regarding languages supported by a reproducing apparatus.

10. The medium of claim 9, wherein the script category information is stored as system parameters of the reproducing apparatus.

11. An apparatus for processing text data, the apparatus comprising:
an extractor extracting one of a plurality of script categories classified according to a language attribute of the text data; and
a text generator rendering the text data according to script information included in the extracted category.

12. The apparatus of claim 11, wherein each of the script categories comprises a plurality of script information, and scripts are used to process units of a plurality of Unicode symbols.

13. The apparatus of claim 12, wherein each script is used to express a character set in the Unicode.

14. The apparatus of claim 11, wherein the script categories indicate information regarding languages supported by a reproducing apparatus.

15. The apparatus of claim 14, wherein the script categories are stored as system parameters of the reproducing apparatus.

16. A reproducing apparatus comprising:
a text data storing unit storing text data encoded in a plurality of languages and script category information classified according to a language attribute of the text data; and
a text data processing unit reading the text data and rendering the text data according to script information included in the script category information.

17. The apparatus of claim 16, further comprising a system parameter storing unit storing the script information that can be processed by the reproducing apparatus as system parameters.

18. A computer-readable recording medium on which a program for executing a method of processing text data is recorded, the method comprising:
extracting one of a plurality of script categories classified according to a language attribute of the text data; and
rendering the text data according to script information included in the extracted category.

19. A method of displaying information, comprising:
rendering first symbols from among a first set of symbols using a font;
rendering second symbols from among a second set of symbols using a script, wherein a direction of presentation of the second symbols is controlled by an attribute of a language associated with the first set of symbols; and
displaying the rendered first and second symbols.

20. The method of claim 19, wherein the rendered first and second symbols are displayed in a first direction.

21. The method of claim 19, wherein:
the rendered first symbols are displayed in a first direction, and
the rendered second symbols are displayed in a second direction.

22. The method of claim 19, wherein:
the rendered first symbols are displayed in a first direction,
some of the rendered second symbols are displayed in a second direction, and
others of the rendered second symbols are displayed in the first direction.

23. The method of claim 21, wherein the second set of symbols includes numbers and signs.

24. The method of claim 23, wherein each sign has a different meaning where displayed in the first direction among the rendered symbols of the first set from a meaning where displayed in the second direction among the rendered symbols of the first set.

25. The method of claim 22, wherein the second set of symbols includes numbers and signs.

26. The method of claim 25, wherein each sign has a different meaning where displayed in the first direction among the rendered symbols of the first set from a meaning where displayed in the second direction among the rendered symbols of the first set.

27. A method of recording information, comprising:
recording first symbols from among a first set of symbols using a font;
recording second symbols from among a second set of symbols using a script; and
recording an attribute indicator of a language associated with the first set of symbols to control a direction of presentation of the second symbols among the first symbols.

28. The method of claim 27, wherein the recorded first and second symbols are to be displayed in a first direction.

29. The method of claim 27, wherein:
the recorded first symbols are to be displayed in a first direction, and
the recorded second symbols are to be displayed in a second direction.

30. The method of claim 27, wherein:
the recorded first symbols are to be displayed in a first direction,
some of the recorded second symbols are to be displayed in a second direction, and
others of the recorded second symbols are displayed in the first direction.

31. The method of claim 29, wherein the second set of symbols includes numbers and signs.

32. The method of claim 31, wherein each sign has different meaning where displayed in the first direction among the recorded symbols of the first set from a meaning where displayed in the second direction among the recorded symbols of the first set.

33. The method of claim 30, wherein the second set of symbols includes numbers and signs.

34. The method of claim 33, wherein each sign has a different meaning where displayed in the first direction among the recorded symbols of the first set from a meaning where displayed in the second direction among the recorded symbols of the first set.

35. A reproducing apparatus comprising:
a text data processing unit reading text data encoded in a regional language and script information corresponding to the regional language and rendering characters for display based on the text data and the script information;
wherein the script information includes information for controlling a display of the characters based on the script information according to an attribute of the regional language.

36. The reproducing apparatus of claim 35, wherein:
the attribute of the regional language is an order of display of first characters for display relative to an order of display of second characters for display.

37. The reproducing apparatus of claim 35, wherein the first characters for display comprise numbers.

38. The reproducing apparatus of claim 35, wherein the first characters for display have a different meaning according to a direction of display of the second characters.

39. A method of processing text data in a reproducing apparatus, the method comprising:
extracting a script category from an information storage medium, the script category corresponding to a language attribute of the text data;
accessing a system parameter of the reproducing apparatus and determining whether the extracted script category is a script category processable by the reproducing apparatus based on the accessed system parameter;
extracting and displaying text data corresponding to first characters to be displayed and script corresponding to second characters to be displayed from the information storage medium, if the extracted script category is determined to be processable by the reproducing apparatus; and
terminating the processing of the text data, if the extracted script category is determined not to be processable by the reproducing apparatus.
